(19) United States
(12) Patent Application Publication
(10) Pub. No.: US 2011/0032229 A1
(43) Pub. Date: Feb. 10, 2011

(54) DISPLAY DEVICE AND ELECTRONIC APPARATUS COMPRISING THE SAME

(75) Inventor: FUMIROU MATSUKI, Chu-Nan (TW)

Correspondence Address: Flash Intellectual Property, Inc.;Attn. Cheng-Ju Chiang, P.O. Box 766, Chino, CA, 91708, US

(73) Assignee: Chimei InnoLux Corporation, Chu-Nan (TW)

(21) Appl. No.: 12/852,447

(22) Filed: Aug. 6, 2010

(30) Foreign Application Priority Data
Aug. 7, 2009 (JP) 2009-183966

(51) Int. Cl. G06F 3/038; G01J 1/44

(52) U.S. Cl. 345/207; 250/214 AL

(57) ABSTRACT

A display device and an electronic apparatus comprising the same are disclosed. The display device can eliminate or reduce a noise effect on a result of detecting ambient light. The display device includes a light detecting device for detecting the ambient light. The light detecting device comprises a light detecting unit, a reference voltage generating unit and a comparing unit. The light detecting unit is configured to generate a light detecting voltage for indicating the intensity of the ambient light. The reference voltage generating unit is configured to generate a predetermined reference voltage. The comparing unit is configured to compare the light detecting voltage with the reference voltage, and includes a first input terminal for allowing the light detecting voltage to be inputted and a second input terminal, which has the polarity opposite to the polarity of the first input terminal, for allowing the predetermined reference voltage to be inputted.

The present application claims the benefit of the filing date under 35 U.S.C. §119(e) of a Japan Patent Application No. 2009-183966, entitled “Display device and electronic apparatus comprising the same”, filed on Aug. 7, 2009, which is incorporated by reference herein.

### FIELD OF THE INVENTION

The present invention relates to a display device, and more particularly, to a display device including a light detecting device to detect ambient light and an electronic apparatus comprising the same.

### BACKGROUND OF THE INVENTION

Currently, a display device which is applicable to a mobile electronic apparatus, such as a vehicle navigation device or a mobile phone, has a brightness regulation function for regulating a display brightness thereof according to the brightness of the ambient light. For example, Japan Patent Publication No. 2001-522058 discloses a display system including a controller to change the brightness of a display according to the ambient light detected by a photo-sensor. By using the brightness regulation function, the brightness of the display is raised under a strong ambient light environment, such as in daytime or being outdoors, and the brightness of the display is reduced under a weak ambient light environment, such as at night or being indoors.

In general, for detecting the ambient light, a display device includes a photo-sensor to detect light and output a photocurrent corresponding to the light-acceptance amount detected by the photo-sensor. The photocurrent can be transformed into a voltage or a digital pulse signal by using a signal converter, such as a current-to-voltage converter or an analog-to-digital converter. A controller regulates the brightness of a backlight source corresponding to the inputted signal. A circuit used for light detecting may be disclosed in JP Patent Publication No. 2008-522159.

However, the conventional light detecting mechanism disposed in the display device is affected by electrical/electromagnetic noises caused by driving a display panel, or a ripple noise of a power line, thereby deteriorating the detecting accuracy.

### SUMMARY OF THE INVENTION

Therefore, an aspect of the present invention is to provide a display device and an electronic apparatus comprising the same for eliminating or reducing a noise effect on the detecting ambient light result of the display device.

According to one embodiment of the present invention, the display device includes a light detecting device for detecting ambient light. The light detecting device comprises a light detecting unit, a reference voltage generating unit and a comparing unit. The light detecting unit is configured to generate a light detecting voltage for indicating the intensity of the ambient light. The reference voltage generating unit is configured to generate a predetermined reference voltage. The comparing unit is configured to compare the light detecting voltage with the reference voltage, and includes a first input terminal for allowing the light detecting voltage to be inputted and a second input terminal, which has the polarity opposite to the polarity of the first input terminal, for allowing the predetermined reference voltage to be inputted.

By means of a differential input structure, the noises can be neutralized, thereby eliminating or reducing the noise effect on the ambient light detecting result of the display device.

In one embodiment, the structure of the reference voltage generating unit is similar to a circuit connected to the first input terminal of the comparing unit.

Therefore, the noise component which is superposed to the reference voltage Vref may be similar to the noise component which is superposed to the light detecting voltage Vp, and thus the common mode noise can be eliminated.

Preferably, the light detecting unit includes a first photodiode for outputting a photocurrent excited by the ambient light, thereby forming the light detecting voltage. At this time, the reference voltage generating unit includes a second photodiode with characteristic and the structure substantially similar to the first photodiode, and the second photodiode is disposed at a location sheltered from the ambient light, and the reference voltage is a voltage between two ends of the second photodiode.

More preferably, the light detecting device further includes a compensating unit for compensating a current outputted due to other reasons except the ambient light, and the compensating unit includes a third photodiode with characteristic and the structure substantially similar to the first photodiode, and the third photodiode is disposed at a location sheltered from the ambient light and connected to a cathode of the first photodiode, and the third photodiode and first photodiode are connected in the same direction and in series. In the case that the compensating unit is provided, the reference voltage generating unit further includes a fourth photodiode with characteristic and the structure substantially similar to the third photodiode, and the fourth photodiode is disposed at a location sheltered from the ambient light and connected to a cathode of the second photodiode, and the fourth photodiode and second photodiode are connected in the same direction and in series.

In one embodiment, the light detecting device further includes a logic circuit, and the logic circuit outputs a pulse signal according to comparing result of the comparing unit, which compares the light detecting voltage with the predetermined reference voltage, and the pulse signal has a duration corresponding to the intensity of the ambient light.

Preferably, the comparing unit comprises a differential input comparator, a first switch and a second switch. The differential input comparator includes a first input terminal and a second input terminal. The first switch is configured to connect the first input terminal of the differential input comparator with a predetermined reset voltage in a reset duration. The second switch is configured to connect the second input terminal of the differential input comparator with a predetermined reset voltage in the reset duration.

In one embodiment, the display device further includes an image display panel which includes a plurality of pixels arranged in a matrix on a glass substrate, and the light detecting device is disposed on the glass substrate of the image display panel.

By assembling the above-mentioned light detecting device in the display panel, the fabrication loading and cost thereof can be reduced.

According to one embodiment of the present invention, the display device is a liquid crystal display (LCD), a transflective LCD or an organic light emission diode (OLED) display device.

According to one embodiment of the present invention, the display device is assembled in the electrical apparatus, such as a mobile phone, a watch, a personal digital assistant (PDA), a personal computer (PC), a vehicle navigation device, a mobile game console, a large display screen disposed outdoors or other electrical apparatus.

For achieving the above-mentioned objectives, according to one embodiment of the present invention, the light detecting device comprises a light detecting unit, a reference voltage generating unit and a comparing unit. The light detecting unit is configured to generate a light detecting voltage for indicating the intensity of the ambient light. The reference voltage generating unit is configured to generate a predetermined reference voltage. The comparing unit is configured to compare the light detecting voltage with the reference voltage, and includes a first input terminal for allowing the light detecting voltage to be inputted and a second input terminal, which has the polarity opposite to the polarity of the first input terminal, for allowing the predetermined reference voltage to be inputted.

Therefore, by means of the device of the invention, the noise effect on the ambient light detecting result can be eliminated or reduced.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing an electrical apparatus including a display device according to one embodiment of the present invention;

FIG. 2 is a block diagram showing a structure of the display device according to a first embodiment of the present invention;

FIG. 3 is a schematic diagram showing a structure of the light detecting device according to a first embodiment of the present invention;

FIG. 4 is a cross-section view showing a display panel according to a first embodiment of the present invention;

FIG. 5 is a timing diagram showing voltages and signals of each element of the light detecting device according to the first embodiment of the present invention;

FIG. 6 is a schematic diagram showing a description of the effect of the external noise on the light detecting device according to a first embodiment of the present invention;

FIG. 7 is a schematic diagram showing a structure of the display device according to a second embodiment of the present invention;

FIG. 8 is a schematic diagram showing a structure of the light detecting device according to a second embodiment of the present invention;

FIG. 9 is a schematic diagram showing a circuit structure of the differential input comparator according to a second embodiment of the present invention;

FIG. 10 is a timing diagram showing voltages and signals of each element of the light detecting device according to the second embodiment of the present invention; and

FIG. 11 is a schematic diagram showing a description of the effect of the external noise on the light detecting device according to a second embodiment of the present invention.

### DETAILED DESCRIPTION OF THE PREFERRED EMBODIMENT

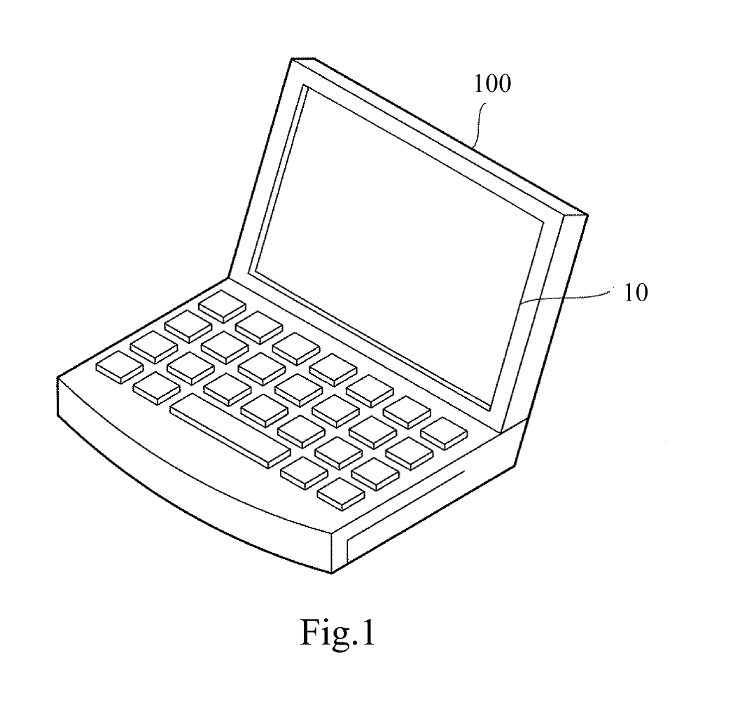

The present invention will be explained more explicit and complete in the following descriptions with reference to FIG. 1 through FIG. 11.

Referring to FIG. 1, presented herein is a schematic diagram showing an electrical apparatus including a display device according to one embodiment of the present invention. The electrical apparatus 100 shown in FIG. 1 can be a portable computer, and also can be other electrical apparatus, such as a mobile phone, a watch, a personal digital assistant (PDA), a personal computer (PC), a vehicle navigation device, a mobile game console or a large display screen disposed outdoors.

The electrical apparatus 100 includes a display device 10 which includes a display panel for displaying image, wherein the display device 10 has a function of detecting ambient light. For example, the display device 10 can change the display brightness according to the detected light intensity.

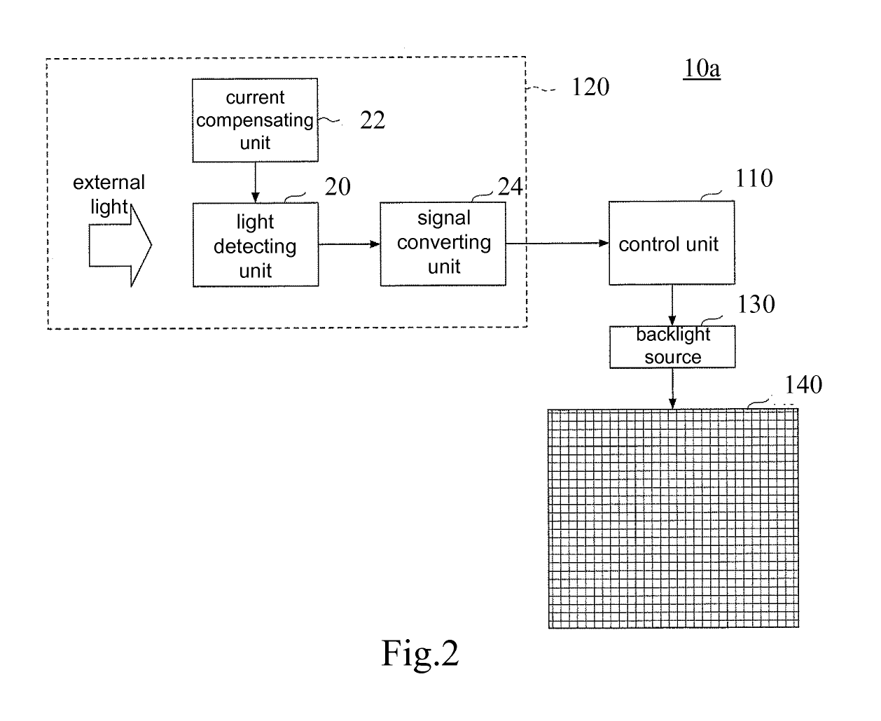

Referring to FIG. 2, presented herein is a block diagram showing a structure of the display device according to one embodiment of the present invention. The display device 10a shown in FIG. 2 may be a transmissive or transflective LCD comprising a control unit 110, a light detecting device 120, a backlight source 130 and a LCD panel 140.

The control unit 110 can control the elements of display device 10. For example, according to a detecting result of the ambient light detected by the light detecting device 120, the control unit 110 can control the backlight source 130 to regulate the display brightness.

The light detecting device 120 comprises a light detecting unit 20, a current compensating unit 22 and a signal converting unit 24. When detecting the ambient light, the light detecting unit 20 outputs a photocurrent corresponding to the light intensity. The current compensating unit 22 is configured to compensate a current which is outputted from the light detecting unit 20 due to other factors except the ambient light. The current may be a dark current or the photocurrent excited by the backlight from the backlight source 130, wherein the dark current is caused by environmental factors, such as temperature, regardless of the ambient light. The signal converting unit 24 can convert the photocurrent outputted from the light detecting unit 20 into a signal, such as a digital signal or a pulse signal, which can be processed by the control unit 110.

The backlight source 130 is disposed at the backside of the display panel 140 to emit light to the pixels thereof arranged in a matrix. The light of the backlight source 130 is controlled by the control unit 110 according to the digital signal or the pulse signal outputted from the signal converting unit 24 of the light detecting device 120.

The orientation of LC molecules can be changed by applying a voltage thereto. By changing the orientation of LC molecules, the light of the backlight source 130 can be polarized for displaying images. Selectively, the display device 10 may also be a display device including an OLED display panel. The OLED display panel may include a plurality of OLED pixels arranged in a matrix to replace the LCD panel 140. At this time, since the OLED display panel is a self-emission type device, the backlight source 130 can be omitted. Again, the control unit 110 can change the driving current of the OLED display panel to regulate the display brightness thereof.

When manufacturing the LCD panel or the OLED display panel, the light detecting device 120 may be formed on a non-display region of a glass substrate of the display panel by using such as a thin film transistor (TFT) technique. Therefore, the light detecting device 120 can be assembled in the display panel for reducing the fabrication loading and cost thereof.

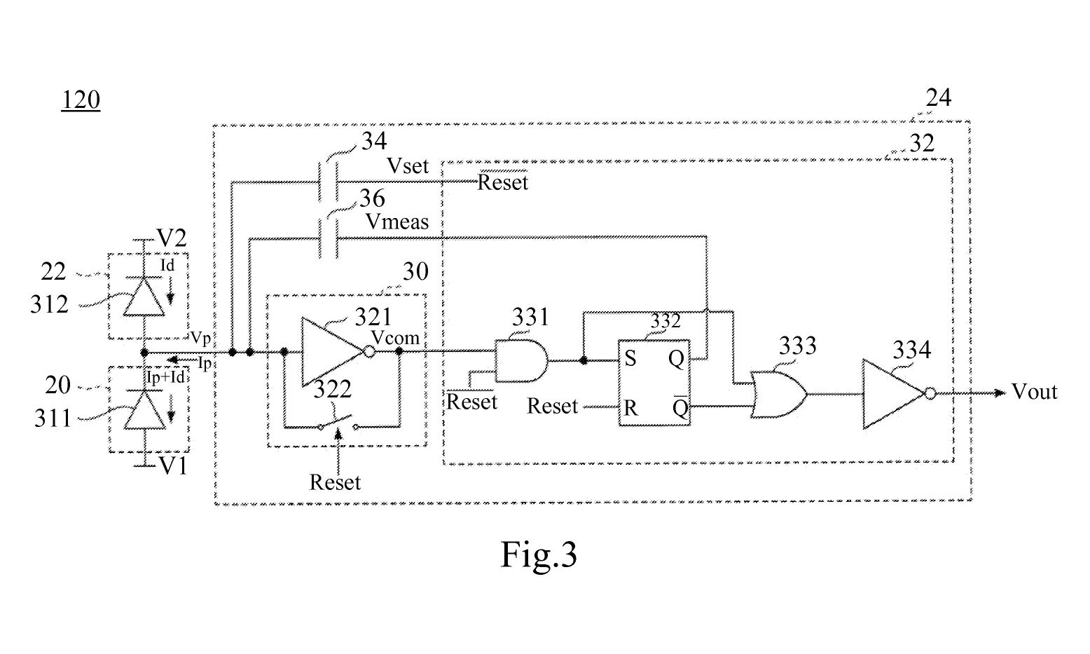

Referring to FIG. 3, presented herein is a schematic diagram showing a structure of the light detecting device according to a first embodiment of the present invention. Referring to FIG. 2 again, the light detecting device 120 comprises a light detecting unit 20, a current compensating unit 22 and a signal converting unit 24.

In the present embodiment, the light detecting unit 20 includes a photodiode 311. The photodiode 311 has a cathode and anode, wherein the cathode is connected to an input terminal of the signal converting unit 24, and the anode is connected to a first predetermined potential V1, such as a ground potential.

In the present embodiment, the current compensating unit 22 includes a photodiode 312. The characteristic and structure of the photodiode 312 is substantially similar to the photodiode 311. The photodiode 312 has a cathode and anode, wherein the cathode is connected to a second predetermined potential V2 (such as power voltage VDD=5V) higher than the first predetermined potential V1, and the anode of the photodiode 312 is connected to the cathode of the photodiode 311. Therefore, the photodiode 311 for light detecting and the photodiode 312 for compensating are connected in the same direction and in series, and the connecting thereof is arranged between the first predetermined potential V1 and the predetermined potential V2.

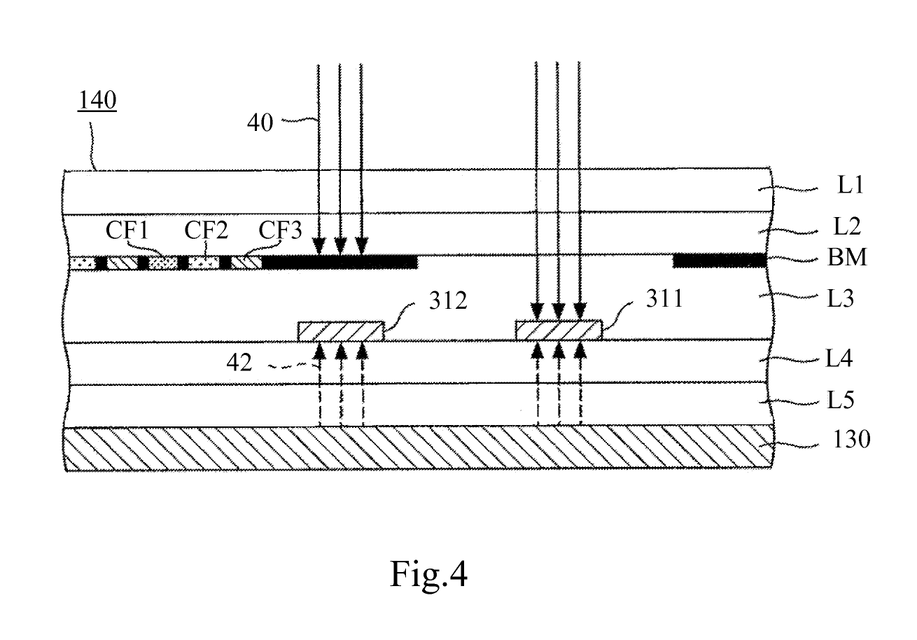

Referring to FIG. 4, the photodiode 311 and the photodiode 312 are arranged on the glass substrate of the display panel of the display device.

Referring to FIG. 4, presented herein is a cross-section view showing a display panel according to a first embodiment of the present invention. The display panel 140 shown in FIG. 4 includes a first polarizer L1, a first glass substrate L2, a liquid crystal layer L3, a second glass substrate L4 and a second polarizer L5 stacked in sequence. The display panel 140 may be transmissive or transflective LCD panel including the backlight source 130 disposed at the backside thereof. The display panel 140 further includes a black matrix layer BM disposed on a surface of the first glass substrate L2 which contacts with the liquid crystal layer L3. The black matrix layer BM can shelter light and generally be made of metal material. The black matrix layer BM is in the form of a grid shape in an active area, which is configured to display image, of the display panel 140. A plurality of color filters CF1, CF2 and CF3 with predetermined colors (such as red (R), green (G) and blue (B)) are formed between the grid shape of the black matrix layer BM. The liquid crystal layer L3 has a matrix arrangement with LC elements. The LC elements can polarize the light 42 emitted from the backlight source 130 according to the applied voltage. The LC elements of the matrix arrangement respectively correspond to the color filters CF1, CF2 and CF3 which are formed between the grid shape of the black matrix layer BM. When applying a voltage to a specific LC element, the color (i.e. R, G or B color) of the color filter corresponding to the specific LC element can be seen in the display panel 140. In other embodiments, an OLED layer including a plurality of white OLED elements arranged in a matrix form can be utilized to replace the liquid crystal layer L3. At this time, since the white OLED elements are self-emission type elements, the backlight source 130 can be omitted. Furthermore, the color filters CF1, CF2 and CF3 can be omitted by utilizing light emitting diodes (LEDs) with R, G and B colors.

In the above-mentioned display panel 140, the photodiode 311 and the photodiode 312 are arranged on a surface of the second glass substrate L4 which contacts with the liquid crystal layer L3. The photodiode 311 for detecting light can receive the external light 40 which passes the first polarizer L1 and the first glass substrate L2. The photodiode 311 for light detecting is excited by the external light 40 and outputs the photocurrent. The photodiode 312 for compensating is arranged on a region, which is covered by the black matrix layer BM without receiving the external light 40, of the second glass substrate L4. Since the characteristic and structure of the compensating photodiode 312 is substantially similar to the detecting photodiode 311, the compensating photodiode can utilized to detect a current outputted from the detecting photodiode 311 due to other factors except the external light 40, wherein the current may be a dark current or the photocurrent excited by the backlight 42 from the backlight source 130, wherein the dark current is caused by environmental factors, such as temperature, regardless of the emitting light.

Since the characteristic and structure of the compensating photodiode 312 is substantially similar to the detecting photodiode 311, the dark current outputted from the photodiode 311 and 312 can be regarded as the same in some environments. For example, for simplifying description, when the backlight source 130 is omitted or turned off, since the compensating photodiode 312 is sheltered from the external light 40 by the black matrix layer BM, there is no photocurrent excited by the external light 40. At this time, the current generated by the compensating photodiode 312 can be regarded as the dark current generated by the detecting photodiode 311.

Furthermore, if the effect of the environmental factor (such as temperature) is ignored, and the backlight source 130 disposed on the display panel 140 is turned on, since the characteristic and structure of the compensating photodiode 312 is substantially similar to the detecting photodiode 311, the photocurrent excited by the backlight 42 of the backlight source 130 and outputted from the photodiode 311 and 312 can be regarded as the same. Therefore, at this time, the current generated by the compensating photodiode 312 can be regarded as the photocurrent excited by the backlight 42 of the backlight source 130 and outputted from the photodiode 311.

Referring to FIG. 3 again, the compensating photodiode 312 is connected to the cathode of the detecting photodiode 311 in the same direction and in series. For example, when the photocurrent Ip excited by the external light 40 and the dark current Id formed by environmental factors (such as temperature) flow through the detecting photodiode 311, a current identical to dark current Id also flows through the compensating photodiode 312. Therefore, the current, which flows from the input terminal of the signal converting unit 24 to a node between the photodiodes 311 and 312, is (Ip+Id)−Id=Ip, identical to the photocurrent Ip excited by the external light 40 and outputted from the detecting photodiode 311.

The signal converting unit 24 includes a comparing unit 30, a logic circuit 32, a capacitor 34 with a capacitance Cfs and a capacitor 36 with a capacitance Cfm. The comparing unit 30 is configured to compare the light detecting voltage Vp with the predetermined reference voltage Vref. The light detecting voltage Vp is generated at the cathode of the photodiode 311 by the current flowing through the photodiode 311. The logic circuit 32 is configured to output a pulse signal Vout according to comparing result of the comparing unit 30 which compares the light detecting voltage Vp with the predetermined reference voltage Vref. The pulse signal Vout has an existing duration corresponding to the intensity of the ambient light 40 and is provided to the control unit 110 shown in FIG. 2.

The comparing unit 30 includes an inverter circuit 321 and a switch 322. The input terminal of the inverter circuit 321 is connected to the node between the photodiodes 311 and 312. When the light detecting voltage Vp formed at the cathode of the detecting photodiode 311 is greater than the reference voltage Vref, the inverter circuit 321 outputs a low voltage (Low). When the light detecting voltage Vp is less than the reference voltage Vref, the inverter circuit 321 outputs a high voltage (High). The reference voltage Vref may be identical to a threshold voltage Vth of the inverter circuit 321. For example, when an upper boundary power voltage of the inverter circuit 321 is the second predetermined potential V2 (such as the power voltage VDD=5V), and a lower boundary power voltage thereof is the first predetermined potential V1 (such as the ground voltage GND), the threshold voltage Vth may be substantially a middle potential between the first predetermined potential V1 and the second predetermined potential V2, such as (V1+V2)/2=(GND+VDD)/2=(0+5)/2=2.5V. The switch 322 is disposed between the input terminal and the output terminal of the inverter circuit 321 for switching responding to a reset signal Reset. The reset signal Reset is provide by the control unit 110 directly, or by the logic circuit 32 indirectly. In a reset duration for initializing the light detecting device 120, the switch 322 is turned off to directly connect the input terminal and the output terminal of the inverter circuit 321.

The logic circuit 32 includes a logic AND circuit 331, a flip-flop circuit 332, a logic OR circuit 333 and an inverter circuit 334. The output signal Vcom of the inverter circuit 321 of the comparing unit 30 and an inverting reset signal R̅e̅s̅e̅t̅ are inputted into the logic AND circuit 331. When the output signal Vcom of the inverter circuit 321 and the inverting reset signal R̅e̅s̅e̅t̅ are High, the output of the logic AND circuit 331 is High. When at least one of the output signal Vcom of the inverter circuit 321 and the inverted reset signal R̅e̅s̅e̅t̅ is Low, the output of the logic AND circuit 331 is Low. The inverting reset signal R̅e̅s̅e̅t̅ is provided by the control unit 110 directly, or by the logic circuit 32 indirectly, and is connected to the node between the photodiodes 311 and 312 by the first capacitor 34. The flip-flop circuit 332 may be a RS flip-flop which has a setting terminal S connected to the output terminal of the logic AND circuit 331 and a reset terminal R connected to the reset signal Reset. A non-inverting output Q of the flip-flop circuit 332 is connected to the node between the photodiodes 311 and 312 by the second capacitor 36. The inverting output Q̅ is connected to an input terminal at one side of the logic OR circuit 333. An input terminal at another side of the logic OR circuit 333 is connected to an output terminal of the logic AND circuit 331. When at least one of the inverting output Q̅ and the output of the logic AND circuit 331 is High, the output of the logic OR circuit 333 is High. When both of the inverting output Q̅ and the output of the logic AND circuit 331 are Low, the output of the logic OR circuit 333 is Low. The output terminal of the logic OR circuit 333 is connected to an input of the inverter circuit 334. The inverter circuit 334 is configured to invert the output of the logic OR circuit 333 for outputting the pulse signal Vout which has the existing duration corresponding to the intensity of the ambient light 40.

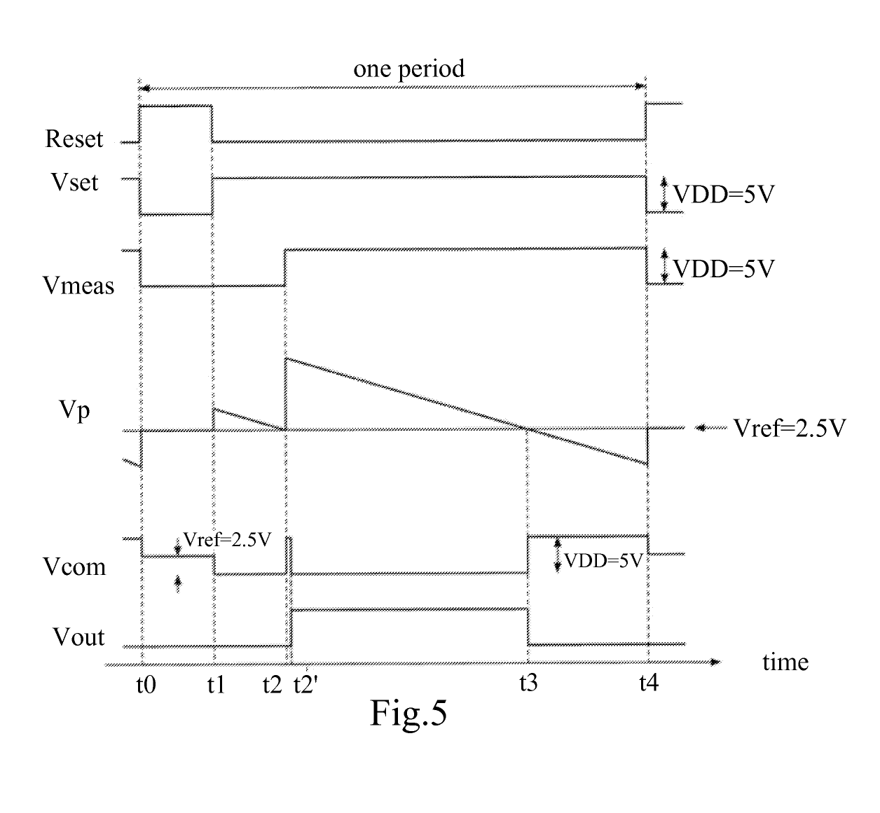

Referring to FIG. 5, below is an explanation of the above-mentioned light detecting device 120.

Referring to FIG. 5 again, presented herein is a timing diagram showing voltages and signals of each element of the light detecting device according to the first embodiment of the present invention. In FIG. 5, the signals varied with time are shown, wherein the signals comprise the reset signal Reset provided by the control unit 110, a setting voltage Vset provided to the first capacitor 34 in a setting duration and a measurement duration of the light detecting device 120, a measurement voltage Vmeas provided to the second capacitor 36 in the measurement duration of the light detecting device 120, the light detecting voltage Vp formed at the node between the photodiodes 311 and 312, a signal Vcom outputted from the comparing unit 30 and a signal outputted from the logic circuit 32 (i.e. the pulse signal Vout outputted from the light detecting device 120) shown in sequence.

One period of the light detecting device 120 for detecting the ambient light is composed of the reset duration for initializing the light detecting device 120, the setting duration for eliminating the offset of the circuit of the light detecting device 120 and the measurement duration for measuring the intensity of the ambient light. In the present embodiment, the duration between the starting and the ending of the reset signal Reset is regarded as the reset duration, and the duration between the starting and the next starting of the reset signal Reset is regarded as one period of the light detecting device 120 for detecting the ambient light. In other embodiments, the reset duration may also be the duration between the ending and the starting of the reset signal Reset. At this time, one period of the light detecting device 120 for detecting the ambient light is regarded as the duration between the ending and the next ending of the reset signal Reset.

Referring to FIG. 5, at time t0, the reset signal Reset is switched from Low to High for starting the reset duration. At this time, the switch 322 of the comparing unit 30 is closed, thereby connecting the input terminal and output terminal of the inverter circuit 321 directly. Therefore, the light detecting voltage Vp in the reset duration is identical to the signal Vcom outputted from the comparing unit 30 and also identical to the threshold voltage Vth of the inverter circuit 321, i.e. the reference voltage Vref=2.5V.

At time t1, the reset signal Reset is switched from High to Low and the setting voltage Vset, which is an inverting signal of the reset signal Reset, is provided to the node between the photodiodes 311 and 312 through the first capacitor 34 for starting the setting duration. For example, the setting voltage Vset may be the power voltage VDD (VDD=5V). The light detecting voltage Vp of VDD×Cfs/(Cpd+Cfm+Cfs) is formed at the node between the photodiodes 311 and 312, wherein the Cfs is the capacitance of the first capacitor 34, and the Cfm is the capacitance of the second capacitor 36, and Cpd is a parasitic capacitor formed at the input terminal of the comparing unit 30. At this time, the light detecting voltage Vp is greater than the reference voltage Vref. Therefore, the output signal Vcom is Low. Then, the light detecting voltage Vp has a tendency of ΔV/Δt=Ip/(Cpd+Cfm+Cfs) with time passing, and thus is gradually reduced.

At time t2, when the light detecting voltage Vp reaches the reference voltage Vref, the output signal Vcom of the comparing unit 30 is switched to High. Therefore, the non-inverting output Q of the flip-flop circuit 332 is High, and the measurement voltage Vmeas is provided to the node between the photodiodes 311 and 312 through the second capacitor 36, thereby starting the measurement duration. For example, the measurement voltage Vmeas, i.e. the non-inverting output Q of the flip-flop circuit 332, may be the power voltage VDD=5V. The light detecting voltage Vp of VDD×Cfm/(Cpd+Cfm+Cfs) is formed at the node between the photodiodes 311 and 312. Since, the light detecting voltage Vp at time t2′ is greater than the reference voltage Vref, the output signal Vcom of the comparing unit 30 is switched from High to Low. The non-inverting output Q of the flip-flop circuit 332 continues to be High. Since both the inverting output Q̅ of the flip-flop circuit 332 and the output of the logic AND circuit 331 are Low, the output of the logic OR circuit 333 is Low, and the output signal Vout of the logic circuit 32 is switched from Low to High.

Then, the light detecting voltage Vp has a tendency of ΔV/Δt=Ip/(Cpd+Cfm+Cfs) with time passing, and thus is gradually reduced. At time t3, when the light detecting voltage Vp reaches the reference voltage Vref, the output signal Vcom of the comparing unit 30 is switched to High, and the output signal Vout of the logic circuit 32 is switched to Low. In the duration when the reset signal is switched from Low to High, the light detecting voltage Vp is gradually reduced.

The detecting photodiode 311 generates the photocurrent Ip by receiving the external light 40, wherein the photocurrent Ip is proportional to the intensity of the external light 40. The higher the intensity of the external light 40 is, the greater the photocurrent Ip outputted from the detecting photodiode 311 is, and according to the expression of ΔV/Δt=Ip/(Cpd+Cfm+Cfs), the faster the time when the light detecting voltage Vp reaches the reference voltage Vref is. According to the above-mentioned relation, the higher the intensity of the external light 40 is, the shorter the duration PW when the output signal Vout of the logic circuit 32 is High is. Furthermore, the relation between the duration PW and the photocurrent Ip can be indicated with the expression of PW=VDD×Cfm/Ip.

Therefore, the pulse signal Vout is provided to the control unit 110 by the light detecting device 120, and the control unit 110 can realize the intensity of the external light 40 by receiving the pulse signal Vout.

Then, the noise occurring outside the light detecting device 120 is considered, wherein the external noise may be an electrical/electromagnetic noise which is caused by driving a display panel, or a ripple noise of a power line.

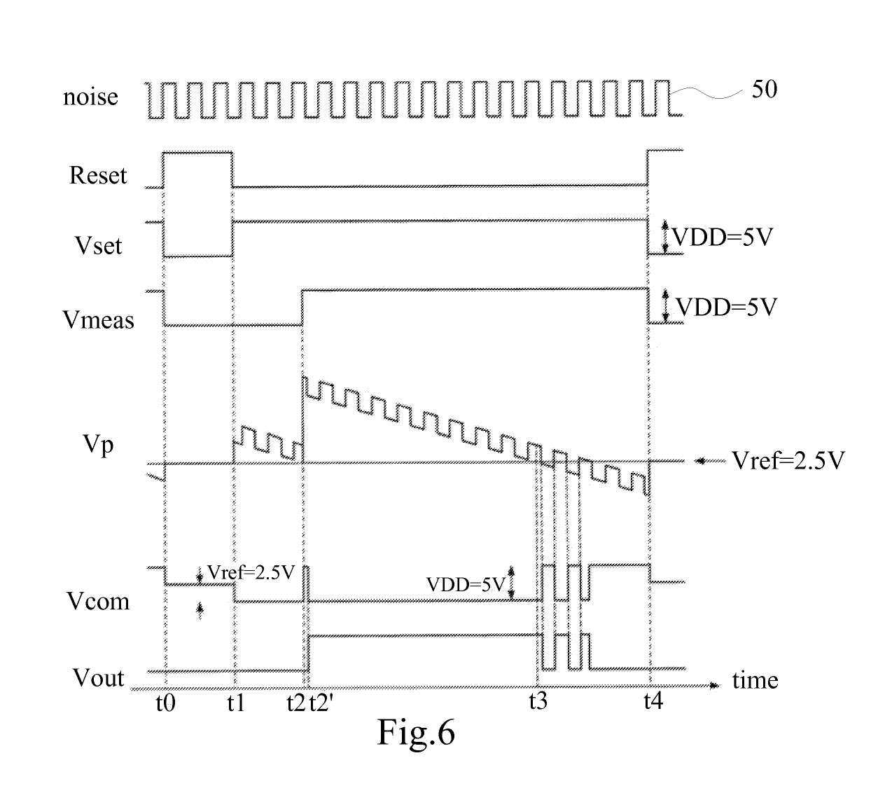

Referring to FIG. 6, presented herein is a schematic diagram showing a description of the effect of the external noise on the light detecting device according to a first embodiment of the present invention. For simplifying description, the external noise 50 shown in FIG. 6 is indicated as a square wave with a fixed period.

When the external noise 50 occurs, the noise component is superposed and provided to the light detecting voltage Vp of the comparing unit 30. The input terminal of the comparing unit 30 is connected to the cathode of the detecting photodiode 311, the terminal of the compensating photodiode 312 and the input terminal of the inverter circuit 321, and has high impedance, and thus is susceptible to be affected by the noise. Since the noise is superposed to the light detecting voltage Vp, the output signal Vcom outputted from the comparing unit 30 and the pulse signal Vout outputted from the logic circuit 32 are also susceptible to be affected by the external noise 50.

In the measurement duration, when the light detecting voltage Vp reaches the reference voltage Vref, the output signal Vout is switched from High to Low. The switching timing is determined by the effect of the noise, and practically is the timing before or after the light detecting voltage Vp reaches the reference voltage Vref. Taking FIG. 6 for example, the timing when the output signal Vout is switched from High to Low is practically later than the timing t3 when the light detecting voltage Vp reaches the reference voltage Vref. Furthermore, the output signal Vout shall be Low after being switched to Low and before the next measurement duration. However, due to the effect of the noise, the output signal Vout is repeatedly switched between High/Low.

Accordingly, when the noise (such as the electrical/electromagnetic noise caused by driving a display panel, or a ripple noise of a power line) occurs outside the light detecting device 120, the control unit can not realize the accurate intensity of the external light 40.

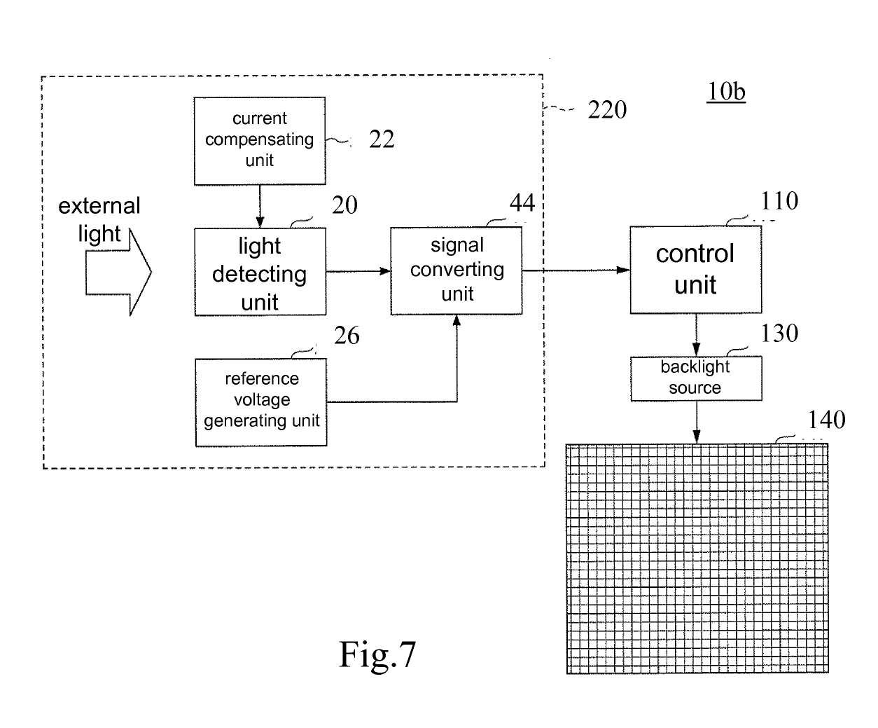

Referring to FIG. 7, presented herein is a schematic diagram showing a structure of the display device according to a second embodiment of the present invention. Concerning the structure of the light detecting device, the display device 10b shown in FIG. 7 is different to the display device 10a shown in FIG. 2. The light detecting device 220 of the display device 10b comprises a light detecting unit 20, a current compensating unit 22 and a signal converting unit 44 and a reference voltage generating unit 26. When the light detecting unit 20 receives light, the photocurrent according to the light intensity is outputted. The current compensating unit 22 is configured to compensate a current which is outputted from the light detecting unit 20 due to other factors except the ambient light. The current may be a dark current or the photocurrent excited by the backlight from the backlight source 130, wherein the dark current is caused by environmental factors, such as temperature, regardless of the ambient light. The signal converting unit 44 can convert the photocurrent outputted from the light detecting unit 20 into a signal, such as a digital signal or a pulse signal, which can be processed by the control unit 110. The reference voltage generating unit 26 is configured to generate the reference voltage Vref which is used for the signal conversion of the signal converting unit 44.

Since the device structure of the display device 10b is similar to the display device 10a except the light detecting device 220, the similarities are not mentioned for simplification.

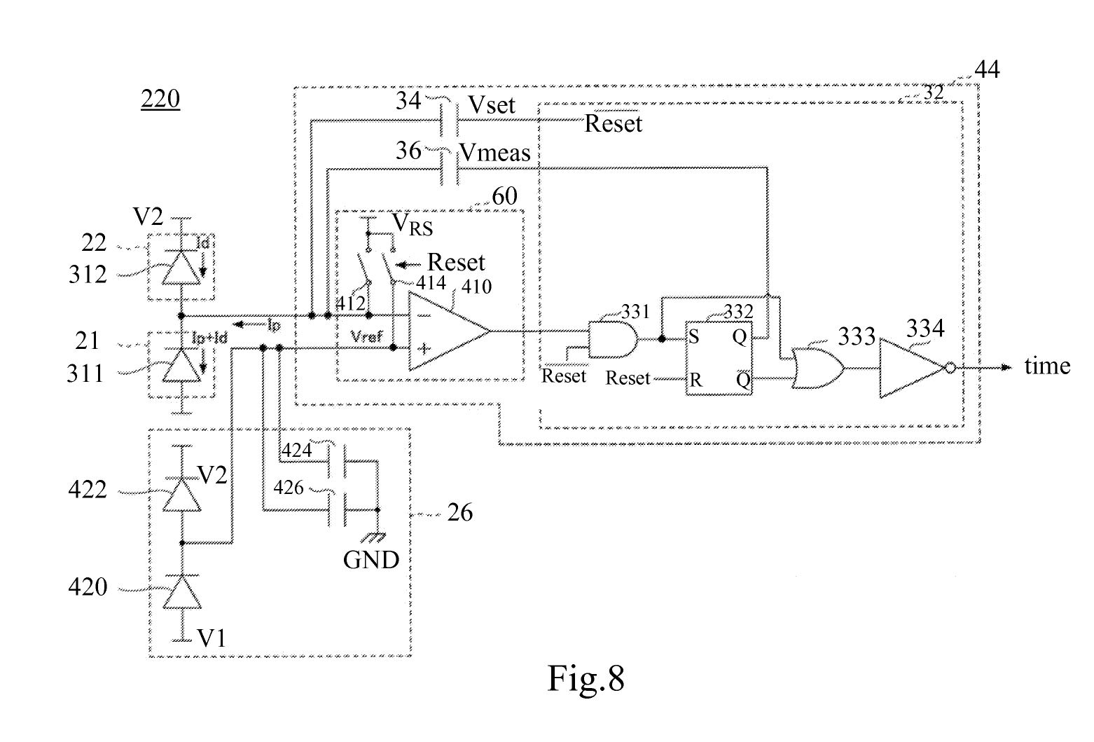

Referring to FIG. 8, presented herein is a schematic diagram showing a structure of the light detecting device according to a second embodiment of the present invention. Concerning the comparing unit 60 of the signal converting unit 44, the display device 10b shown in FIG. 8 is different to the display device 10a shown in FIG. 3. The comparing unit 60 includes a differential input comparator 410, a first switch 412 and a second switch 414.

The differential input comparator 410 includes an inverting input terminal and a non-inverting input terminal, wherein the inverting input terminal is connected to the node between the photodiodes 311 and 312, and the non-inverting input terminal is connected to the reference voltage Vref generated from the reference voltage generating unit 26. The differential input comparator 410 is configured to compare the light detecting voltage Vp forming at the node between the photodiodes 311 and 312 with the reference voltage Vref. When the light detecting voltage Vp is greater than the reference voltage Vref, the output of the differential input comparator 410 is Low. When the light detecting voltage Vp is less than the reference voltage Vref, the output of the differential input comparator 410 is High.

The first switch 412 is disposed between a reset voltage V_{RS} and the inverting input terminal of the differential input comparator 410. The second switch 414 is disposed between a reset voltage V_{RS} and the non-inverting input terminal of the differential input comparator 410. The switches 412 and 414 perform switching responding to the reset signal Reset which is provide by the control unit 110 directly, or by the logic circuit 32 indirectly. In the reset duration for initializing the light detecting device 220, the switches 412 and 414 are closed to connect the inverting input terminal and the non-inverting input terminal with the reset voltage V_{RS}.

The structure of the reference voltage generating unit 26 is similar to the circuit connected to the inverting input terminal of the differential input comparator 410, and comprises a first photodiode 420, a second photodiode 422, a third capacitor 424 and a fourth capacitor 426, wherein the characteristic and structure of the first photodiode 420 are substantially similar to the detecting photodiode 311, and the characteristic and structure of the second photodiode 422 are substantially similar to the compensating photodiode 312, and the characteristic and structure of the third capacitor 424 and the fourth capacitor 426 are respectively similar to the first capacitor 34 and the second capacitor 36 of the signal converting unit 44. The anode of the first photodiode 420 is connected to the first predetermined potential V1 which is connected to the anode of the detecting photodiode 311. The cathode of the first photodiode 420 is connected to the anode of the second photodiode 422, and the cathode of the second photodiode 422 is connected to the second predetermined potential V2 which is connected to the cathode of the compensating photodiode 312. The third capacitor 424 and the fourth capacitor 426 are connected in parallel between the non-inverting input terminal of the differential input comparator 410 and the ground potential GND.

The first photodiode 420 and the second photodiode 422 are similar to the compensating photodiode 312 shown in FIG. 4 arranged on the region, which is covered by the black matrix layer BM without receiving the external light 40, of the second glass substrate L4. Therefore, the first photodiode 420 and the second photodiode 422 can not receive the external light 40.

According to the partial voltage of the first photodiode 420 and the second photodiode 422, the reference voltage generating unit 26 generates the reference voltage Vref equal to the middle voltage of (V1+V2)/2=2.5V between the first predetermined potential V1 and the second predetermined potential V2.

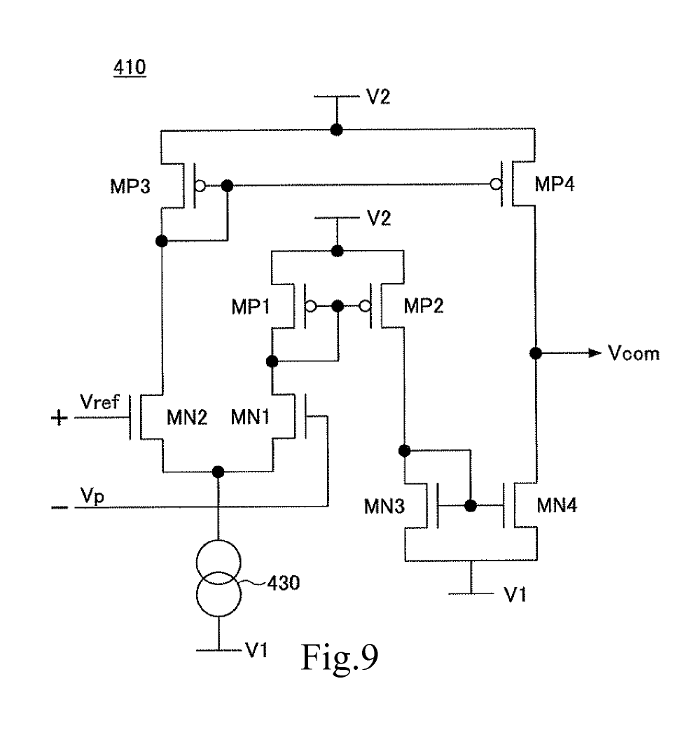

Referring to FIG. 9, presented herein is a schematic diagram showing a circuit structure of the differential input comparator 410 according to a second embodiment of the present invention.

The differential input comparator 410 includes a first NMOS transistor MN1 having a gate electrode connected to the inverting input terminal and a second NMOS transistor MN2 having a gate electrode connected to the non-inverting input terminal, wherein source electrodes of the first NMOS transistor MN1 and the second NMOS transistor MN2 are respectively connected to a current source 430. When the light detecting voltage Vp inputted to the inverting input terminal is greater than the reference voltage Vref inputted to the non-inverting input terminal, the first NMOS transistor MN1 is turned on. On the contrary, when the light detecting voltage Vp is less than the reference voltage Vref, the second NMOS transistor MN2 is turned on.

A drain electrode of the first NMOS transistor MN1 is connected to a drain electrode of a first PMOS transistor MP1. The drain electrode of the first PMOS transistor MP1 is further connected to a gate electrode of the first PMOS transistor MP1. The gate electrode of the first PMOS transistor MP1 is further connected to a gate electrode of the second PMOS transistor MP2, wherein source electrodes of the first PMOS transistor MP1 and the second PMOS transistor MP2 are respectively connected to the second predetermined potential V2, such as the power voltage VDD=5V. A drain electrode of the second PMOS transistor MP2 is connected to a drain electrode of a third NMOS transistor MN3. The drain electrode of a third NMOS transistor MN3 is further connected to a gate electrode of the third NMOS transistor MN3. The gate electrode of the third NMOS transistor MN3 is further connected to a gate electrode of a fourth NMOS transistor MN4, wherein source electrodes of the third NMOS transistor MN3 and the fourth NMOS transistor MN4 are respectively connected to the first predetermined potential V1, such as the ground voltage GND. A drain electrode of the fourth NMOS transistor MN4 can be the output terminal of the differential input comparator 410. Therefore, when the first NMOS transistor MN1 is turned on, the first PMOS transistor MP1, the second PMOS transistor MP2, the third NMOS transistor MN3 and the fourth NMOS transistor MN4 are turned on, and the signal Vcom outputted from the comparator 410 is Low.

The drain electrode of the second NMOS transistor MN2 is connected to a drain electrode of a third PMOS transistor MP3. The drain electrode of the third PMOS transistor MP3 is further connected to a gate electrode of the third PMOS transistor MP3. The gate electrode of the third PMOS transistor MP3 is further connected to a gate electrode of a fourth PMOS transistor MP4, wherein source electrodes of the third PMOS transistor MP3 and the fourth PMOS transistor MP4 are respectively connected to the second predetermined potential V2. A drain electrode of the fourth PMOS transistor MP4 is connected to the drain electrode of the fourth NMOS transistor MN4 to be the output terminal of the comparator 410. Therefore, when the second NMOS transistor MN2 is turned on, the third PMOS transistor MP3 and the fourth PMOS transistor MP4 are turned on, and the signal Vcom outputted from the comparator 410 is High.

Accordingly, when the light detecting voltage Vp is greater than the reference voltage Vref, the output of the differential input comparator 410 is Low. On the contrary, when the light detecting voltage Vp is less than the reference voltage Vref, the output of the differential input comparator 410 is High.

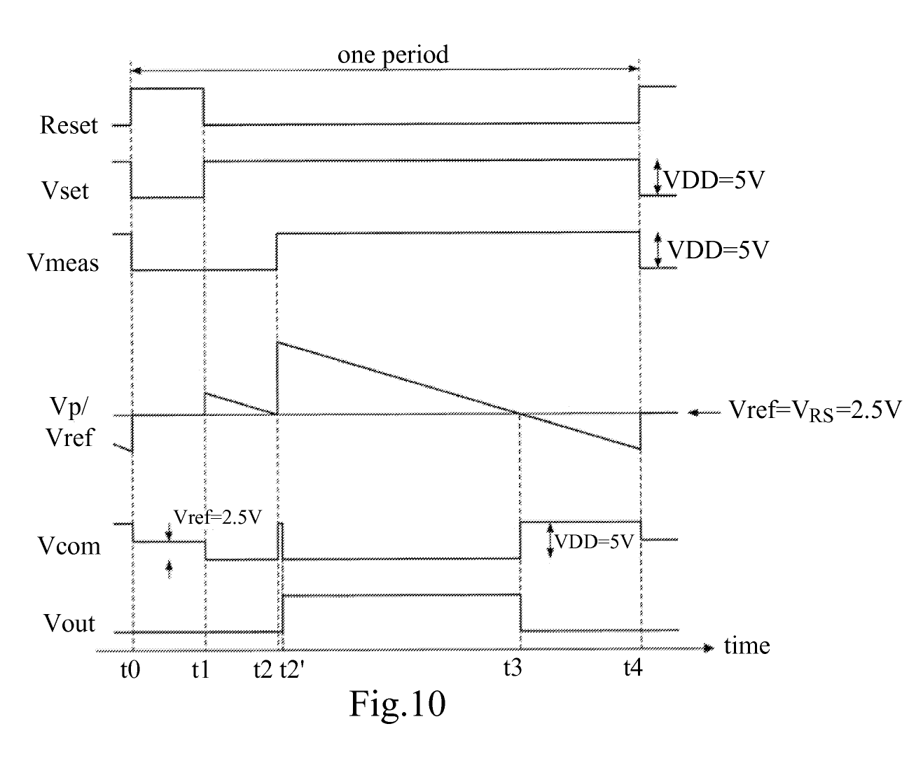

Referring to FIG. 10, below is an explanation of the above-mentioned light detecting device 220 shown in FIG. 8.

Referring to FIG. 10 again, presented herein is a timing diagram showing voltages and signals of each element of the light detecting device according to the second embodiment of the present invention. In FIG. 10, the signals varied with time are shown, wherein the signals comprise the reset signal Reset provided by the control unit 110, a setting voltage Vset provided to the first capacitor 34 in a setting duration and a measurement duration of the light detecting device 220, a measurement voltage Vmeas provided to the second capacitor 36 in and the measurement duration of the light detecting device 220, the light detecting voltage Vp formed at the node between the photodiodes 311 and 312, the reference voltage Vref inputted to the non-inverting input terminal of the differential input comparator 410, the signal Vcom outputted from the comparing unit 60 and the signal outputted from the logic circuit 32 (i.e. the pulse signal Vout outputted from the light detecting device 220) shown in sequence.

Referring to FIG. 10 again, at time t0, the reset signal Reset is switched from Low to High for starting the reset duration. At this time, the first switch 412 and the second switch 414 of the comparing unit 60 are closed, and thus the inverting input terminal and the non-inverting input terminal are respectively connected to the reset voltage V_{RS}. The reset voltage V_{RS} may be the power voltage of the comparator 410, and preferably the middle voltage of (V1+V2)/2 between the first predetermined potential V1 and the second predetermined potential V2. In this embodiment, the reset voltage V_{RS} may be (GND+VDD)/2=(0+5)/2=2.5V. At this time, according to the partial voltage formed in the comparator 410, the signal Vcom outputted from the comparing unit 60 may be substantially the middle voltage of (V1+V2)/2=2.5V between the first predetermined potential V1 and the second predetermined potential V2.

At time t1, the reset signal Reset is switched from High to Low, and the setting voltage Vset, which is an inverting signal of the reset signal Reset, is provided to the node between the photodiodes 311 and 312 through the first capacitor 34 for starting the setting duration. For example, the setting voltage Vset may be the power voltage VDD (VDD=5V). The light detecting voltage Vp of VDD×Cfs/(Cpd+Cfm+Cfs) is formed at the node between the photodiodes 311 and 312, wherein the Cfs is the capacitance of the first capacitor 34, and the Cfm is the capacitance of the second capacitor 36, and Cpd is a parasitic capacitor formed at the input terminal of the comparing unit 60. At this time, the light detecting voltage Vp is greater than the reference voltage Vref. Therefore, the output signal Vcom of the comparing unit 60 is Low. Then, the light detecting voltage Vp has a tendency of ΔV/Δt=Ip/(Cpd+Cfm+Cfs) with time passing, and thus is gradually reduced.

At time t2, when the light detecting voltage Vp reaches the reference voltage Vref, the output signal Vcom of the comparing unit 60 is switched to High. Therefore, the non-inverting output Q of the flip-flop circuit 332 is High, and the measurement voltage Vmeas is provided to the node between the photodiodes 311 and 312 through the second capacitor 36, thereby starting the measurement duration. For example, the measurement voltage Vmeas, i.e. the non-inverting output Q of the flip-flop circuit 332, may be the power voltage VDD=5V. The light detecting voltage Vp of VDD×Cfm/(Cpd+Cfm+Cfs) is formed at the node between the photodiodes 311 and 312. Since, the light detecting voltage Vp at time t2′ is greater than the reference voltage Vref, the output signal Vcom of the comparing unit 60 is switched from High to Low. The non-inverting output Q of the flip-flop circuit 332 continues to be High. Since both the inverting output Q̅ of the flip-flop circuit 332 and the output of the logic AND circuit 331 are Low, the output of the logic OR circuit 333 is Low, and the output signal Vout of the logic circuit 32 is switched from Low to High.

Then, the light detecting voltage Vp has a tendency of ΔV/Δt=Ip/(Cpd+Cfm+Cfs) with time passing, and thus is gradually reduced. At time t3, when the light detecting voltage Vp reaches the reference voltage Vref, the output signal Vcom of the comparing unit 60 is switched to High, and the output signal Vout of the logic circuit 32 is switched to Low. In the duration when the reset signal is switched from Low to High, the light detecting voltage Vp is gradually reduced.

Similar to the light detecting device 120 shown in FIG. 5 according to the first embodiment, the detecting photodiode 311 generates the photocurrent Ip by receiving the external light 40, wherein the photocurrent Ip is proportional to the intensity of the external light 40. Therefore, the higher is the intensity of the external light 40, the shorter is the duration PW when the output signal Vout of the logic circuit 32 is High. Furthermore, the relation between the duration PW and the photocurrent Ip can be indicated with the expression of PW=VDDx Cfm/Ip.

Therefore, the pulse signal Vout is provided to the control unit 110 by the light detecting device 220, and the control unit 110 can realize the intensity of the external light 40 by pulse width PW of the pulse signal Vout.

Then, the noise occurring outside the light detecting device 220 is considered, wherein the external noise may be an electrical/electromagnetic noise which is caused by driving a display panel, or a ripple noise of a power line.

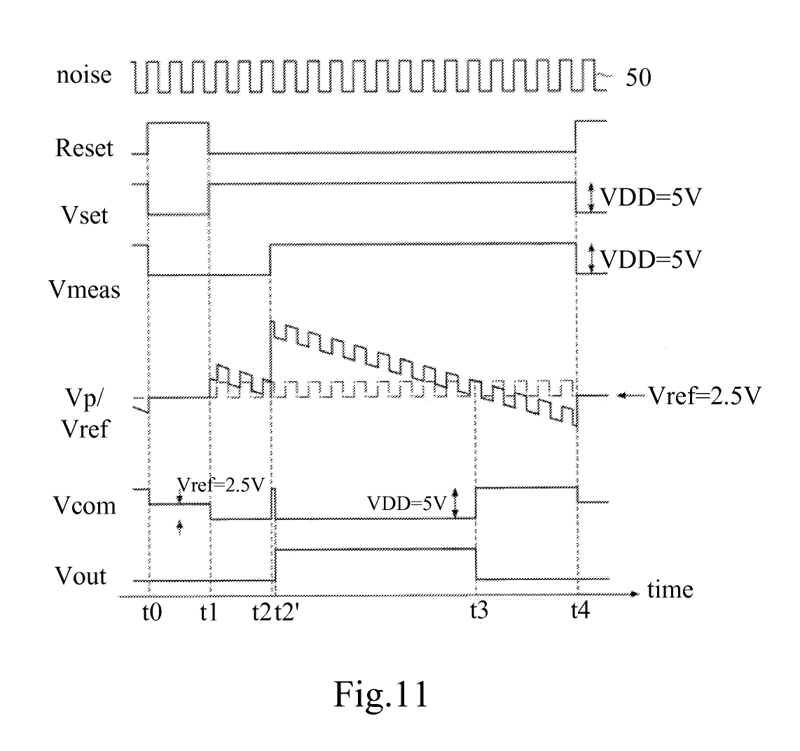

Referring to FIG. 11, presented herein is a schematic diagram showing a description of the effect of the external noise on the light detecting device according to a second embodiment of the present invention. For simplifying description, the external noise 50 shown in FIG. 11 is indicated as a square wave with a fixed period.

When the external noise 50 occurs, the noise component is superposed and provided to the light detecting voltage Vp inputted to the inverting input terminal of the differential input comparator 410 of the comparing unit 60. Similarly, referring to the dot-dash line shown in FIG. 11, the noise component is also superposed to the reference voltage Vref inputted to the non-inverting input terminal of the differential input comparator 410 of the comparing unit 60. However, the effect of the external noise 50 is not seen in the output signal Vcom of the comparing unit 60. This is because the comparing unit 60 has the differential input structure, and the noise component superposed to the light detecting voltage Vp can be neutralized by the noise component superposed to the reference voltage Vref. Since the structure of the reference voltage generating unit 26 is similar to the circuit connected to the inverting input terminal of the differential input comparator 410, the noise component which is superposed to the reference voltage Vref may be similar to the noise component which is superposed to the light detecting voltage Vp, and thus the common mode noise can be eliminated.

Therefore, the effect of the external noise 50 is not seen in the final pulse signal Vout outputted from the light detecting device 220, and the control unit 110 can realize the accurate intensity of the external light 40 regardless of external noise 50. By means of the differential input structure, the noises can be neutralized, thereby eliminating or reducing the noise effect on the ambient light detecting result of the display device.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

For example, in the above-mentioned embodiments, the existing duration of the pulse signal outputted from the light detecting device is proportional to the intensity of the ambient light, and the existing duration may be also inversely proportional to the intensity of the ambient light.

Furthermore, as is understood by a person skilled in the art, the structures of the differential input comparator and logic circuit may be formed by other types but not limited to the above description. In the above-mentioned embodiments, the light detecting voltage Vp is inputted to the inverting output terminal, and the reference voltage Vref is inputted to the non-inverting output terminal. However, the reference voltage Vref can be also inputted to the inverting output terminal, and the light detecting voltage Vp can be also inputted to the inverting output terminal.

Selectively, the light detecting device can output a signal for indicate the light intensity of a predetermined light source but not limited to the display device having the ambient light detecting function, and can be assembled or utilized in varied machine or apparatus.

What is claimed is:

1. A display device including a light detecting device for detecting ambient light, wherein the light detecting device comprises:
a light detecting unit configured to generate a light detecting voltage for indicating the intensity of the ambient light;
a reference voltage generating unit configured to generate a predetermined reference voltage; and
a comparing unit configured to compare the light detecting voltage with the predetermined reference voltage and including a first input terminal and a second input terminal, wherein the light detecting voltage is inputted to the first input terminal, and the polarity of the second input terminal is opposite to the polarity of the first input terminal for allowing the predetermined reference voltage to be inputted.

2. The display device of claim 1, further comprising a circuit connected to the first input terminal of the comparing unit, the circuit has a structure similar to the reference voltage generating unit.

3. The display device of claim 1, wherein the light detecting unit includes a first photodiode for outputting a photocurrent excited by the ambient light, thereby forming the light detecting voltage, and the reference voltage generating unit includes a second photodiode with the characteristic and structure substantially similar to the first photodiode, and the second photodiode is disposed at a location sheltered from the ambient light, and the reference voltage is a voltage between two ends of the second photodiode.

4. The display device of claim 3, wherein the light detecting device further includes a compensating unit for compensating a current outputted due to other factors except the ambient light, and the compensating unit includes a third photodiode with the characteristic and structure substantially similar to the first photodiode, and the third photodiode is disposed at a location sheltered from the ambient light and connected to a cathode of the first photodiode, and the third photodiode and the first photodiode are connected in the same direction and in series.

5. The display device of claim 4, wherein the reference voltage generating unit further includes a fourth photodiode with the characteristic and structure substantially similar to the third photodiode, and the fourth photodiode is disposed at a location sheltered from the ambient light and connected to a cathode of the second photodiode, and the fourth photodiode and second photodiode are connected in the same direction and in series.

6. The display device of claim 1, wherein the light detecting device further includes a logic circuit, and the logic circuit outputs a pulse signal according to comparing result of the comparing unit, which compares the light detecting voltage with the predetermined reference voltage, and the pulse signal has a duration corresponding to the intensity of the ambient light.

7. The display device of claim 1, wherein the comparing unit comprises:
a differential input comparator including a first input terminal and a second input terminal;
a first switch configured to connect the first input terminal of the differential input comparator with a predetermined reset voltage in a reset duration; and
a second switch configured to connect the second input terminal of the differential input comparator with the predetermined reset voltage in the reset duration.

8. The display device of claim 1, wherein the display device further includes an image display panel which includes a plurality of pixels arranged in a matrix on a glass substrate, and the light detecting device is disposed on the glass substrate of the image display panel.

9. The display device of claim 1, wherein the display device is a liquid crystal display (LCD), a transflective LCD or an organic light emission diode (OLED) display device.

10. An electrical apparatus comprising the display device of claim 1.

11. A light detecting device comprising:
a light detecting unit configured to generate a light detecting voltage for indicating the intensity of the ambient light;
a reference voltage generating unit configured to generate a predetermined reference voltage; and
a comparing unit configured to compare the light detecting voltage with the predetermined reference voltage and including a first input terminal and a second input terminal, wherein the light detecting voltage is inputted to the first input terminal, and the polarity of the second input terminal is opposite to the polarity of the first input terminal for allowing the predetermined reference voltage to be inputted.
